(19) United States
(12) Patent Application Publication
(10) Pub. No.: US 2010/0092718 A1
(43) Pub. Date: Apr. 15, 2010

(54) WAFER MOUNT TAPE, WAFER PROCESSING APPARATUS AND METHOD OF USING THE SAME FOR USE IN THINNING WAFERS

(76) Inventors: Hee Min SHIN, Chungcheongbuk-do (KR); Cheol Ho JOH, Seoul (KR); Eun Hye DO, Gyeonggi-do (KR); Ji Eun KIM, Gyeonggi-do (KR); Kyu Won LEE, Seoul (KR)

Correspondence Address: LADAS & PARRY LLP, 224 SOUTH MICHIGAN AVENUE, SUITE 1600, CHICAGO, IL, 60604, US

(21) Appl. No.: 12/346,097

(22) Filed: Dec. 30, 2008

(30) Foreign Application Priority Data
Oct. 10, 2008 (KR) 10-2008-0103754

(51) Int. Cl. B32B 3/02; B32B 37/00

(52) U.S. Cl. 428/66.4; 156/538; 156/60; 156/281

(57) ABSTRACT

A wafer mount tape, a wafer processing apparatus and an associated method of using the wafer mount tape for use in wafer thinning operations is presented. The wafer mount tape includes a tape body, a first adhesive member and a second adhesive member. The tape body has a first region, a second region and a third region. The first region of the tape body is for being disposed onto a wafer. The second region of the tape body is defined along a periphery of the first region. The third region of the tape body is defined along a periphery of the second region. The first adhesive member is disposed at the first region. The second adhesive member is disposed at the third region.

### CROSS-REFERENCE TO RELATED APPLICATIONS

The present application claims priority to Korean patent application number 10-2008-0103754 filed on Oct. 10, 2008, which is incorporated herein by reference in its entirety.

### BACKGROUND OF THE INVENTION

The present invention relates to semiconductor fabrication, more particularly, to a wafer mount tape and wafer processing apparatus and method using the same.

In recent times, there have been developed a semiconductor chip and a semiconductor package capable of storing and processing massive amounts of data within a relatively short time period.

To reduce volume and thickness of the semiconductor package, techniques on polishing the rear face of a wafer formed with semiconductor chips has been developed.

Unfortunately, when the thickness of the wafer is reduced as a result of polishing down the rear surface of the wafer, the shape of the wafer may become significantly deformed. This significant deformation of the wafer may result in causing frequent defects in singulation process in which the semiconductor chip is singulated from the wafer and die attaching process.

### SUMMARY OF THE INVENTION

Embodiments of the present invention are directed to a wafer mount tape for preventing deformation of a wafer after reducing the thickness of the wafer.

Also, embodiments of the present invention are directed to a wafer processing apparatus that reduces the thickness of the wafer and prevents deformation of the wafer.

Also, embodiments of the present invention are directed to a wafer processing method that reduces the thickness of the wafer and prevents deformation of the wafer.

In one embodiment, a wafer mount tape comprises a tape body having a first region for disposing a wafer, a second region defined along a periphery of the first region and the third region defined along a periphery of the second region; a first adhesive member disposed at the first region; and a second adhesive member disposed at the third region.

The first region has the same shape and size as the wafer.

The first and second adhesive members include an adhesive material having an adhesive strength capable of being weakened by exposure to light.

In another embodiment, a wafer mount tape comprises a first tape having a first region for disposing a wafer, a second region defined along a periphery of the first region and the third region defined along a periphery of the second region; an adhesive member covering an upper face of the first tape; and a second tape having the same shape and size as the second region and covering the adhesive member disposed at the second region.

The first region has the same shape and size as the wafer.

The adhesive member includes an adhesive material having an adhesive strength capable of being is reduced by light exposure.

In yet another embodiment, a wafer processing apparatus comprises a base body; a loader disposed over the base body and accommodating wafer ring attached to a first wafer mount tape attached to a front face of a wafer; a wafer processing module disposed over the base body and including a processing unit processing a first face of the wafer to reduce the thickness of the wafer and a wafer chuck facing to the first wafer mount tape; a mount tape attaching module disposed over the base body and including an elevator unit lifting up and down the wafer with reduced thickness and a tape attaching unit attaching a second wafer mount tape to a front face of the wafer and the wafer ring; and an unloader accommodating the wafer ring to which the second wafer mount tape is attached.

The wafer processing apparatus may further comprise at least one transfer unit disposed over the base body and transferring the wafer ring to one of the loader, the wafer processing module, the mount tape attaching module and the unloader.

The wafer chuck includes a vacuum pressure generating unit and the wafer processing unit has a polishing wheel with at least one polishing pad.

At least one of the wafer chuck and the processing unit further includes an up/down unit for moving up and down the wafer chuck and the processing unit.

The wafer processing apparatus may further comprise a cleaning module disposed over the base body and having a cleaning chamber into which cleaner for cleaning the wafer is provided and a cleaner supplying unit for providing the cleaner into the cleaning chamber.

The first wafer mount tape includes a tape body having a first region for disposing a wafer, a second region defined along a periphery of the first region and the third region defined along a periphery of the second region, a first adhesive member disposed at the first region, and a second adhesive member disposed at the third region.

The first and second adhesive members include an adhesive material having an adhesive strength capable of being weakened by exposing it to light.

The first wafer mount tape includes a first tape having a first region for disposing a wafer, a second region defined along a periphery of the first region and the third region defined along a periphery of the second region, an adhesive member covering an upper face of the first tape, and a second tape having the same shape and size as the second region and covering the adhesive member disposed at the second region.

The wafer processing apparatus may further comprise a mount tape stripping module disposed over the base body and including a light generation unit generating light provided to the first wafer mount tape for stripping the first wafer mount tape from the wafer ring.

The mount tape stripping module includes a light irradiation unit for irradiating the light generated from the light generation unit onto the entire surface of the first wafer mount tape.

In yet another embodiment, a wafer processing method comprises attaching a first wafer mount tape disposed at a rear face of the wafer to a lower face of a wafer ring; processing the rear face of the wafer to reduce a thickness of the wafer; adjusting a height difference between the rear face of the wafer and an upper face of the wafer ring which faces to the rear face of the wafer; and attaching a second wafer mount tape to the rear face of the wafer and the upper face of the wafer ring.

The wafer processing method may further comprise before the step of attaching the first mount tape to the rear face of the wafer ring, forming a tape body having a first region to which the wafer is attached, a second region defined along a periphery of the first region and the third region defined along a periphery of the second region; and fabricating the first wafer mount tape by forming first and second adhesive members at the first and third regions respectively.

The step of processing the rear face of the wafer includes fixing a rear face of the first wafer mount tape opposite to the front face on which the wafer is disposed with a wafer chuck; and polishing down the rear face of the wafer with a polishing pad.

The step of processing the rear face of the wafer further includes a step moving up and down at least one of the wafer chuck or the polishing pad in response to the polishing of the rear face of the wafer.

The step of adjusting the height difference between the rear face of the wafer and the upper face of the wafer ring which faces to the rear face of the wafer includes raising the wafer chuck disposed on the rear face of the first wafer mount tape opposite to the front face on which the wafer is disposed.

The wafer processing method may further comprise, between the step of processing the rear face of the wafer to reduce the thickness of the wafer and the step of adjusting the height difference between the rear face of the wafer and the upper face of the wafer ring which faces to the rear face of the wafer, cleaning the polished wafer with a cleaner.

The wafer processing method may further comprise, after the step of attaching the second wafer mount tape to the rear face of the wafer and the upper face of the wafer ring, stripping the first wafer mount tape away from the wafer and the wafer ring.

The step of stripping the first wafer mount tape includes irradiating light onto an adhesive material having an adhesive strength reduced so that the first wafer mount tape can be stripped away from the wafer ring.

### BRIEF DESCRIPTION OF THE DRAWINGS

FIG. 1 is a plan view illustrating a wafer mount tape in accordance with an embodiment of the present invention.

FIG. 2 is a cross-sectional view taken along line I-I′ in FIG. 1.

FIG. 3 is a plan view illustrating a wafer mount tape in accordance with another embodiment of the present invention.

FIG. 4 is a cross-sectional view taken along line II-II′ in FIG. 3.

FIG. 5 is a plan view illustrating a wafer processing apparatus in accordance with an embodiment of the present invention.

FIG. 6 is a cross-sectional view illustrating an example of a wafer ring to which a first wafer mount tape with a wafer thereon is attached.

FIG. 7 is a cross-sectional view illustrating another example of a wafer ring to which a first wafer mount tape with a wafer thereon is attached.

FIG. 8 is a cross-sectional view illustrating a wafer processing module in FIG. 5.

FIG. 9 is a cross-sectional view illustrating a cleaning module in the wafer processing apparatus in accordance with an embodiment of the present invention.

FIG. 10 is a cross-sectional view illustrating a mount tape attaching module in FIG. 5.

FIG. 11 is a cross-sectional view illustrating a mount tape stripping module in FIG. 5.

FIG. 12 is a flowchart illustrating a wafer processing method in accordance with an embodiment of the present invention.

### DESCRIPTION OF SPECIFIC EMBODIMENTS

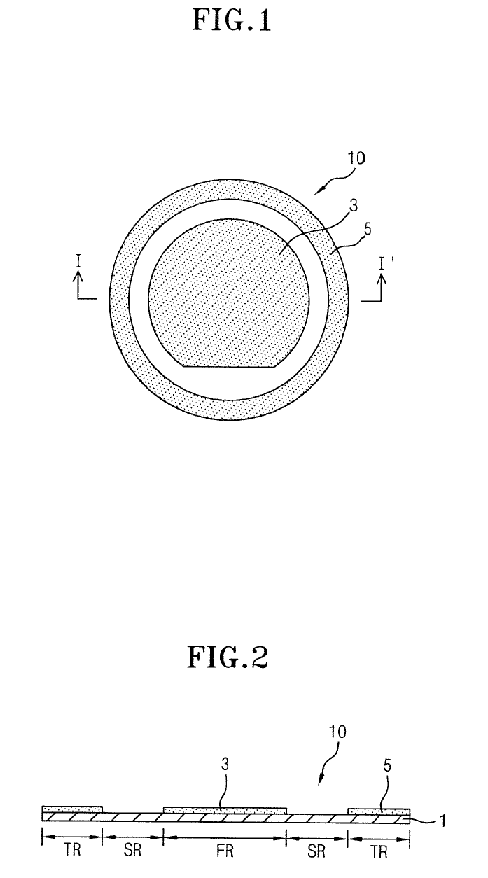

FIG. 1 is a plan view illustrating a wafer mount tape in accordance with an embodiment of the present invention. FIG. 2 is a cross-sectional view taken along line I-I′ in FIG. 1.

Referring FIGS. 1 and 2, a wafer mount tape 10 includes a tape body 1, a first adhesive member 3 and a second adhesive member 5.

The tape body 1 has a disc shape when viewed from above plan view. The tape body 1 may include e.g. a flexible synthetic resin. In the present embodiment, the tape body 1 includes a transparent synthetic resin capable of transmitting light such as ultra violet radiation, infra red heat radiation, ultrasonic waves and supersonic waves. While the tape body 1 is described and illustrated to have a disc shape in the present embodiment, the tape body 1 may any number of different shapes such as being shaped as a rectangle, a square, an ellipse, a rhombus and even having an irregular shape.

The tape body 1 is divided into a first region FR, a second region SR and a third region TR.

The first region FR of the tape body 1 is disposed at the center of the tape body 1. The first region FR may have, e.g., the same shape and size as a wafer. The second region SR of the tape body 1 is defined along a periphery of the first region FR. The second region SR may have, e.g., a donut shape. The third region TR of the tape body 1 is defined along a periphery of the second region SR, and the third region TR may also have a donut shape.

The first adhesive member 3 is disposed at the first region FR of the tape body 1. The first adhesive member 3 has substantially the same shape and size as the first region FR. The first adhesive member 3 may have an adhesive strength capable of being weakened, e.g., by exposure to UV light, heat, ultrasonic waves and/or supersonic waves.

The second adhesive member 5 is disposed at the third region TR of the tape body 1. The second adhesive member 5 can have substantially the same shape and size as the third region TR. The second adhesive member 5 may include an adhesive material in which its adhesive strength is reduced or weakened, e.g., by exposure to UV light, heat, ultrasonic waves and/or supersonic waves.

In the present embodiment, the wafer (not shown) is attached to the first adhesive member formed in the first region FR, and a wafer ring (not shown) is attached to a second adhesive member 5 formed in the third region TR.

In the present embodiment, the adhesive member is not formed in the second region SR of the tape body 1. As the adhesive member is not formed at the second region SR, it is possible to prevent contamination of a polishing wheel by the adhesive member during the time the wafer is polished by the polishing wheel with a polishing pad.

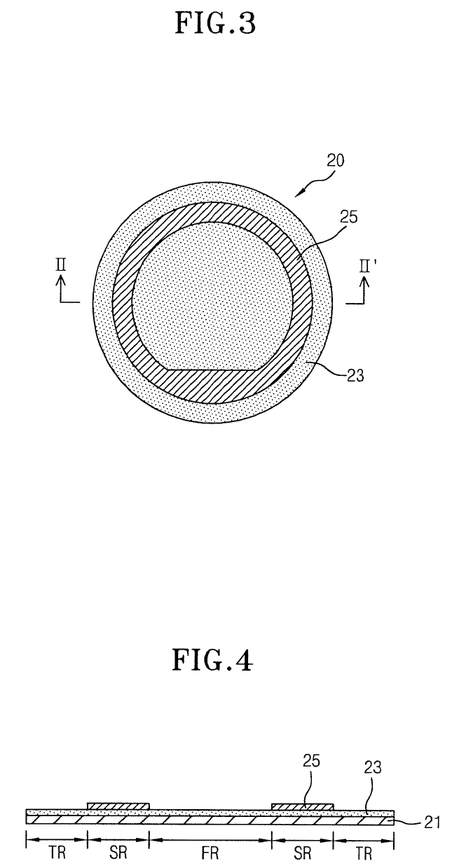

FIG. 3 is a plan view illustrating a wafer mount tape in accordance with another embodiment of the present invention. FIG. 4 is a cross-sectional view taken along line II-II′ in FIG. 3.

Referring to FIGS. 3 and 4, a wafer mount tape 20 includes a first tape body 21, an adhesive member 23 and a second tape body 25.

The first tape body 21 may include e.g. a flexible synthetic resin. In the present embodiment, the first tape body 21 includes a transparent synthetic resin capable of transmitting UV light, heat, ultrasonic waves and/or supersonic waves. While the first tape body 21 is described and illustrated to have a disc shape in the present embodiment, the first tape body 21 may have any number of different shapes.

Again the first tape body 21 can be divided into a first region FR, a second region SR and a third region TR.

The first region FR of the first tape body 21 is disposed at the center of the first tape body 21. The first region FR can have, e.g., substantially the same shape and size as a wafer. The second region SR of the first tape body 21 is defined along a periphery of the first region FR and the second region SR may also have a donut shape. The third region TR of the first tape body 21 is defined along a periphery of the second region SR and the third region TR may also have a donut shape.

The adhesive member 23 is disposed over the first to third regions FR, SR, TR of the first tape body 21. That is, the adhesive member 23 is disposed over the entire surface of the first tape body 21. The adhesive member 23 may include an adhesive material of in which its adhesive strength can be reduced, e.g., by UV light, heat, ultrasonic waves and/or supersonic waves.

The second tape body 25 is disposed over the adhesive member 23. Specifically, the second tape body 25 is disposed over the second region SR and the second tape body 25 has substantially the same shape and size as the second region SR. In the present embodiment, the second tape body 25 may be made of substantially the same material as the first tape body 21.

In the present embodiment, a front face of the wafer is attached onto the adhesive member disposed at the first region FR exposed by the second tape body 25, and the wafer ring is attached onto the adhesive member disposed at the third region TR exposed by the second tape body 25.

In the present embodiment, since the second tape body 25 is disposed at the second region SR, it is possible to prevent contamination of a polishing wheel by the adhesive member during the time when the wafer is polished by the polishing wheel with a polishing pad.

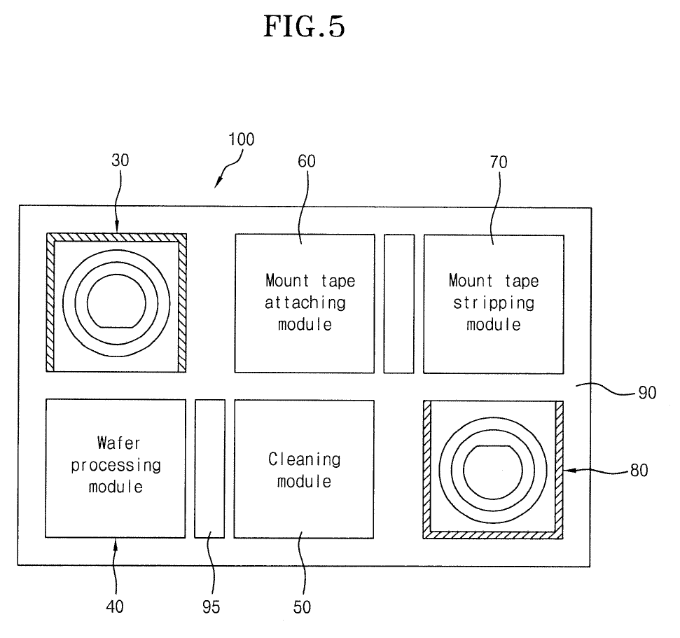

FIG. 5 is a plan view illustrating a wafer processing apparatus in accordance with an embodiment of the present invention.

Referring to FIG. 5, a wafer processing apparatus 100 includes a loader 30, a wafer processing module 40, a mount tape attaching module 60, an unloader 80 and a base body 90. Also, the wafer processing apparatus 100 may further include a cleaning module 50 and a mount tape stripping module 70.

The loader 30 is disposed over the base body 90. The loader may accommodate a plurality of wafer rings to which a first wafer mount tape may be attached to a thick wafer.

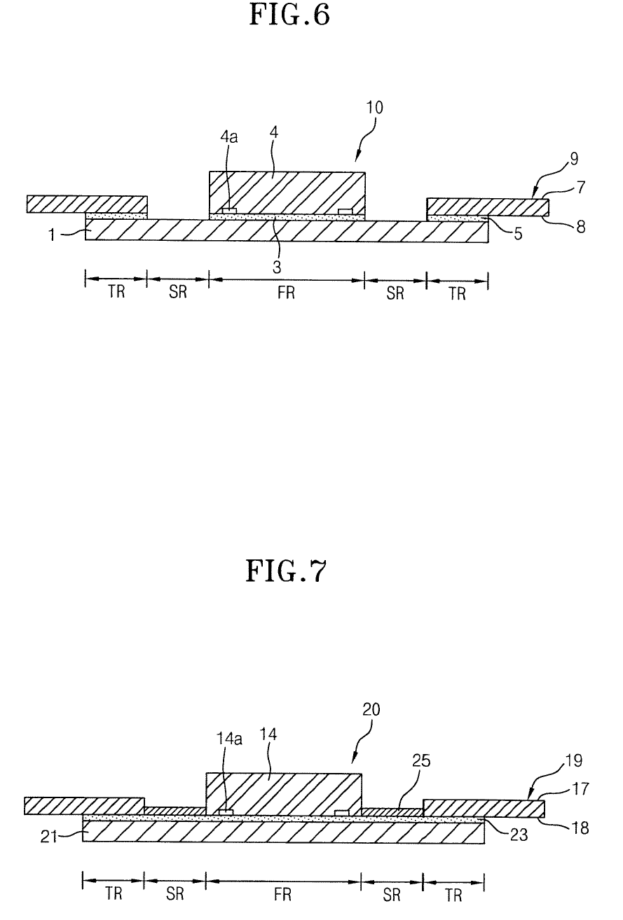

FIG. 6 is a cross-sectional view illustrating an example of a wafer ring to which a first wafer mount tape with a wafer thereon is attached.

Referring to FIG. 6, the first wafer mount tape 10 is attached to a lower face 8 of the wafer ring 9. The first wafer mount tape 10 includes a tape body 1 having a first adhesive member 3 disposed at a first region FR and a second adhesive member 5 disposed at a third region TR. The wafer ring 9 has a donut shape when viewed from above the plan view.

The first adhesive member 3 of the first wafer mount tape 10 is shown attached to a front face of a thick wafer 4. The second adhesive member 5 of the first wafer mount tape 10 is shown attached the lower face 8 of the wafer ring 9.

FIG. 7 is a cross-sectional view illustrating another example of a wafer ring to which a first wafer mount tape with a wafer thereon is attached.

Referring to FIG. 7, a first wafer mount tape 20 is attached to a lower face of a wafer ring 19. The first wafer mount tape 20 includes a first tape body 21 and a second tape body 25. The first tape body 21 is shown having a first, a second and a third region FR, SR, TR, respectively. The first tape body 21 includes an adhesive member 23 which is shown to cover the first to third regions FR, SR, TR. The second tape body 25 is shown attached to the adhesive member 23 corresponding to the second region SR. The wafer ring 19 has a donut shape when viewed from above the plan view.

The thick wafer 14 is shown attached onto the adhesive member 23 corresponding to the first region FR of the first wafer mount tape 20. The lower face 18 of the wafer ring 19 is shown attached to the adhesive member 23 corresponding to the third region TR. A front face of the wafer 14 formed with a bonding pad 14a is shown attached to the adhesive member 23.

In the present embodiment, the loader 30 accommodates the wafer rings 9 to which the first wafer mount tape 10, shown in FIG. 1, is attached.

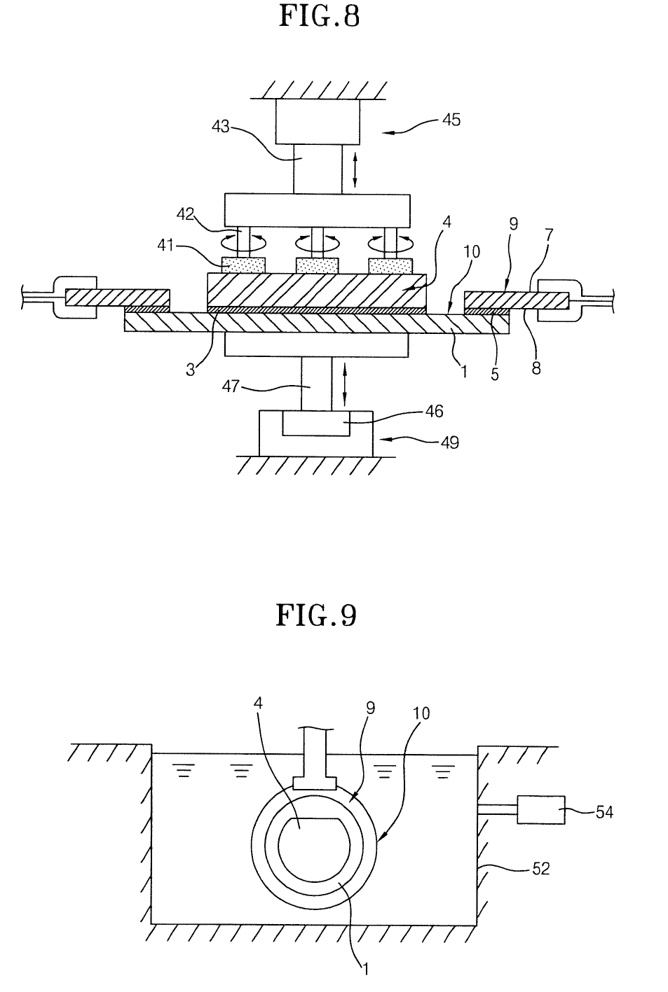

FIG. 8 is a cross-sectional view illustrating a wafer processing module of FIG. 5.

Referring now to FIG. 8, the wafer processing module 40 is disposed over the base body 90. The wafer processing module 40 can be disposed adjacent to the loader 30. In the present embodiment, the wafer processing module 40 polishes down the rear face of the thick wafer 4 to reduce the entire thickness of the wafer.

The wafer processing module 40 includes a processing unit 45 and a wafer chuck 49.

The processing unit 45 faces the rear face of the wafer 4. The processing unit can includea polishing wheel 42 with a polishing pad 41. The polishing wheel 42 rotates the polishing pad 41. The polishing pad 41 polishes down the rear face of the thick wafer 4 to reduce the overall thickness of the wafer 4.

While the processing unit is illustrated in FIG. 8 to polish down the rear face of the wafer 4 using the polishing pad 41 and the polishing wheel 42 in the present embodiment, the processing unit 45 may alternately reduce the overall thickness of the wafer 4 by either using a dry etching process or a wet etching process.

The wafer chuck 49 faces the wafer mount tape 10 and the wafer chuck 49 supports the wafer mount tape 10. In the present embodiment, the wafer chuck 49 includes a vacuum pressure generator for attaching onto the wafer mount tape 10 using a vacuum pressure. Alternatively, the wafer chuck 49 may secure itself onto the wafer mount tape 10 by using static electricity.

Meanwhile, the wafer processing module 40 may further include up/down units 43, 47. The up/down units 43, 47 are shown disposed at the wafer chuck 49 and/or at the processing unit 45.

The up/down units 43, 47 can apply a predetermined pressure to the polishing pad 41 and the rear face of the wafer 4 when the rear face of the wafer 4 is polished by the processing unit 45.

The cleaning module 50 may be disposed over the base body 90. The cleaning module 50 may be disposed adjacent to the wafer processing module 90.

The cleaning module 50 removes contaminant from the wafer 4 with a thickness reduced by using the wafer processing module 40, the wafer mount tape 10 and the wafer ring 9.

FIG. 9 is a cross-sectional view illustrating a cleaning module in the wafer processing apparatus in accordance with an embodiment of the present invention.

The cleaning module 50 includes a cleaning chamber 52 and a cleaner supplying unit 54 for providing cleaner into the cleaning chamber 52.

The cleaning chamber has a large enough space for accommodating the wafer ring 9. The cleaner supplying unit 54 supplies cleaning solutions such as de-ionized DI water into the cleaning chamber 52. The wafer ring 9 to which the first wafer mount tape 10 with the wafer is attached is dipped in the cleaning solution and contaminants are removed from the wafer 4 and the first wafer mount tape 10.

While the cleaning module 50 is illustrated with reference to FIG. 9 to clean most of the contaminant stuck onto the wafer 4, the first wafer mount tape 10 and the wafer ring 9 by using a cleaning solution such as DI water in the present embodiment, it may be possible to remove the contaminants from the wafer 4, the first wafer mount tape 10 and the wafer ring 9 by injecting the cleaning solution onto the wafer 4, the first wafer mount tape 10 and the wafer ring 9 disposed within the cleaning chamber 52. Alternatively, the cleaning solution may be a cleaning gas. Alternatively, the contaminants stuck onto the wafer 4, the first wafer mount tape 10 and the wafer ring 9 may be removed by using ultrasonic and/or supersonic waves.

Also, the cleaning module 50 may further include a cleaner removing unit (not shown). After most of the contaminant stuck onto the wafer 4, the first wafer mount tape 10 and the wafer ring 9 is successfully removed, the cleaner removing unit can subsequently remove the cleaning solution off of the wafer 4, the first wafer mount tape 10 and the wafer ring 9. For example, in a case that the cleaner is a cleaning solution, the cleaner removing unit may include a heater and/or a blowing unit for blowing hot air heated by the heater.

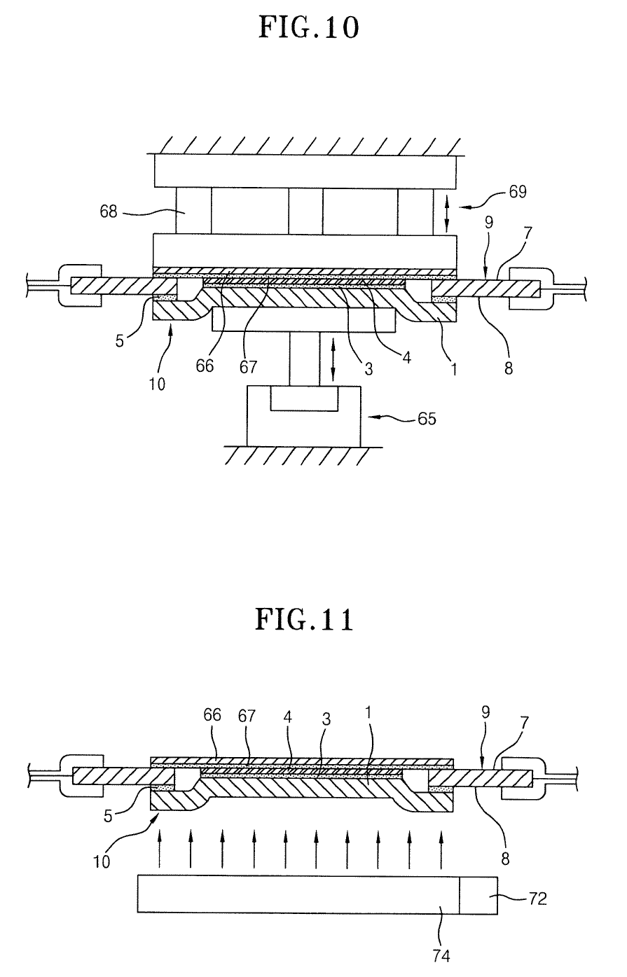

FIG. 10 is a cross-sectional view illustrating a mount tape lo attaching module in FIG. 5.

Referring to FIG. 10, the mount tape attaching module 60 is disposed over the base body 90. In the present embodiment, the mount tape attaching module 60 attaches a second mount tape to a rear face of the wafer 4 with the thickness reduced by the wafer processing module 40.

The mount tape attaching module 60 includes an elevator unit 65 and a tape attaching unit 69.

The elevator unit 65 is disposed on a rear face of the first wafer mount tape 10. The elevator unit 65 lifts up and down the polished wafer 4 which is attached to the first wafer mount tape 10.

A height difference between the rear face of the polished wafer 4 and the lower surface 8 of the wafer ring 9 is reduced by the up/down movement of the elevator unit 65. In the present embodiment, the rear face of the polished wafer 4 and the upper surface 8 of the wafer ring 9 may be disposed e.g. on the same plane by the elevator unit 65. Alternatively, the rear face of the polished wafer 4 may be projected from the upper surface 8 of the wafer ring 9.

The tape attaching unit 69 is disposed such that it faces the polished wafer 4. The tape attaching unit 69 disposes the second wafer mount tape 66 over the rear face of the polished wafer 4 and an upper surface 7 of the wafer ring 9. The second wafer mount tape 66 includes an adhesive layer 67 such that the adhesive layer 67 is disposed at a face of the second wafer mount tape 66 which faces the polished wafer 4. In the present embodiment, the adhesive layer 67 having adhesive strength which can be reduced by UV light, heat, ultrasonic waves and/or supersonic waves.

The tape attaching unit 69 includes an up/down unit 68, and the up/down unit 68 attaches to the adhesive layer 67 of the second wafer mount tape 66 attached to the tape attaching unit 69 to the rear face of the polished wafer 4 and an upper surface 7 of the wafer ring 9.

FIG. 11 is a cross-sectional view illustrating a mount tape stripping module in FIG. 5.

Referring to FIG. 11, the mount tape stripping module 70 is disposed over the base body 90. The mount tape stripping module 70 strips the first wafer mount tape 10 attached to the lower face 8 of the wafer ring 9 from the polished wafer 4.

In a case that the first adhesive member 3 and the second adhesive member 5 to which the polished wafer 4 and the first wafer mount tape 10 are attached include an adhesive material having its adhesive strength capable of being reduced by exposure to UV light, the mount tape stripping module 70 includes a light generation unit for generating light such as UV and a light irradiation unit 74 for providing the UV light to the first wafer mount tape 10. The first and second adhesive members 3, 5 are stripped from the polished wafer 4 and the lower face 8 of the wafer ring 9 by the light generated from the mount tape stripping module 70.

Meanwhile, in a case where the first adhesive member 3 and the second adhesive member 5, to which the polished wafer 4 and the first wafer mount tape 10 are attached, include an adhesive material having its adhesive strength capable of being reduced by heat, the mount tape stripping module 70 may include a heat generation unit (not shown) for providing the heat to the first and second adhesive members 3, 5. The first and second adhesive members 3, 5 are then stripped from the polished wafer 4 and the lower face 8 of the wafer ring 9 by the heat generated from the mount tape stripping module 70.

In the case where the first adhesive member 3 and the second adhesive member 5, to which the polished wafer 4 and the first wafer mount tape 10 are attached, include an adhesive material having an adhesive strength which is capable of being reduced by exposure to supersonic waves, the mount tape stripping module 70 may include a supersonic wave generation unit (not shown) for providing the supersonic wave to the first and second adhesive members 3, 5. The first and second adhesive members 3, 5 are then stripped from the polished wafer 4 and the lower face 8 of the wafer ring 9 by the supersonic wave generated from the mount tape stripping module 70.

The unloader 80 is disposed over the base body 90 and the unloader 80 accommodates the wafer ring 9 from which the first wafer mount tape 10 is stripped by the mount tape stripping module 70. The wafer ring 9 accommodated in the unloader 80 is transferred to a sawing component for performing wafer sawing process or a die attach component for performing die attaching process.

Referring again to FIG. 5, the wafer processing apparatus 100 further include a transfer unit 95 which transfers the wafer ring 9 among the loader 30, the wafer processing module 40, the cleaning module 50, the wafer tape attaching module 60 and the mount tape stripping module 70. The transfer unit 95 may be a robot arm having a gripper for gripping the wafer ring 9.

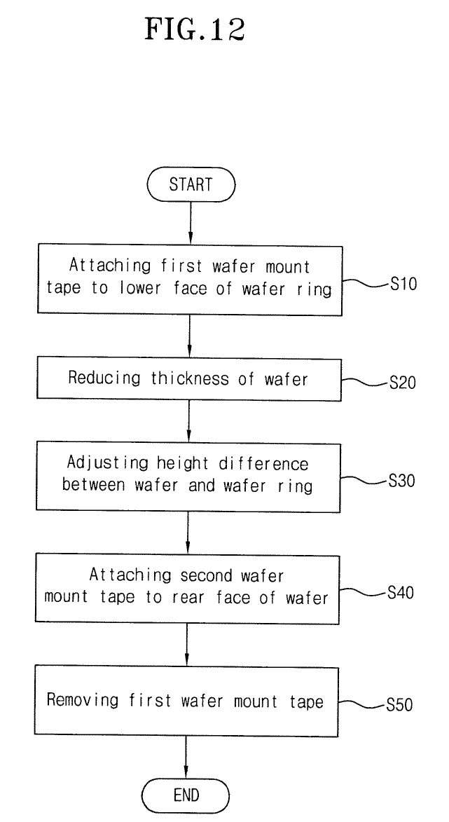

FIG. 12 is a flowchart illustrating a wafer processing method in accordance with an embodiment of the present invention.

Referring to FIG. 12, in a step S10, the front face of the thick wafer is attached to the center of the first wafer mount tape as shown in FIG. 2.

Specifically, the front face of the wafer is disposed at the first region of the tape body of the first wafer mount tape, and the third region of the tape body which is defined along the periphery of the second region defined along the periphery of the first region is attached to the lower face of the wafer ring with a donut shape.

In the present embodiment, the first adhesive member is formed at the first region to the first wafer mount tape and the front face of the wafer. The second adhesive member is formed at the third region to the first wafer mount tape and lower face of the wafer ring. The adhesive member is not disposed at the second region.

The first and second adhesive members include an adhesive material having an adhesive strength capable of being weakened or reduced by exposure to energy waves selected from the group consisting of UV light, heat, ultrasonic waves and supersonic waves.

In a step S20, after the first wafer mount tape, to which the thick wafer is attached, is attached to the wafer ring, the process of reducing the thickness of the thick wafer is performed. For example, the rear face of the thick wafer which is disposed over the first wafer mount tape is polished down by a polishing process, and the resultant thickness of the wafer is significantly reduced. Alternatively, the thickness of the wafer may be significantly reduced by performing either a dry etching process using plasma or wet etching process which etches the rear face of the thick wafer.

After the thickness of the thick wafer is reduced by the polishing process or the etching process, a cleaning process for removing the contaminants, generated during the process of reducing the thickness of the wafer from the wafer, the first wafer mount tape and the wafer ring, may be performed.

The cleaning process may be performed using a cleaner such as a cleaning solution. For example, in the cleaning process, the wafer ring may be dipped into the cleaning solution to remove the contaminants from the wafer, the first wafer mount tape and the wafer ring. Alternatively, the contaminants may be removed from the wafer, the first wafer mount tape and the wafer ring by injecting the cleaning solution onto the wafer, the first wafer mount tape and the wafer ring disposed within the cleaning chamber.

The cleaning process may be performed using a cleaner such as dry cleaning gas selected from the group consisting of He gas, Ar gas, N₂ gas, and CO₂ gas.

The contaminants may also be removed from the wafer, the first wafer mount tape and the wafer ring by applying supersonic waves after dipping the wafer ring into the cleaning solution.

After cleaning the polished wafer, the first wafer mount tape and the wafer ring, the polished wafer has a very thin thickness as compared to the thickness of the wafer ring.

In a step S30, a process of reducing the height difference between the rear face of the polished wafer and the wafer ring is performed. In order to reduce the height difference between the rear face of the polished wafer and the wafer ring, the rear face of the first wafer mount tape may be raised to reduce the height difference between the rear face of the polished wafer and the wafer ring. In the present embodiment, the rear face of the first wafer mount tape is raised by the wafer chuck capable of up/down movements. In the step 30, the rear face of the polished wafer and the surface of the wafer ring are disposed over substantially the same plane.

After the rear face of the polished wafer and the surface of the wafer ring are disposed over substantially the same plane, in a step S40, the second wafer mount tape is attached to the rear face of the polished wafer and the wafer ring. The second wafer mount tape has an adhesive layer in which its adhesive strength can be reduced by exposure to either UV light, heat, ultrasonic waves, or supersonic waves. The rear face of the polished wafer and the wafer ring are attached to the second wafer mount tape by the adhesive layer.

After the rear face of the polished wafer and the wafer ring are attached to the second wafer mount tape, in a step S50, the first wafer mount tape attached to the front face of the polished wafer and the wafer ring is removed from the front face of the polished wafer and the wafer ring.

In the case that the first adhesive member and the second adhesive member, to which the polished wafer and the first wafer mount tape are attached, include an adhesive material in which its adhesive strength is reduced by exposure to light such as UV light, the UV light is irradiated onto the first wafer mount tape and the first wafer mount tape to remove it from the wafer and the wafer ring.

In the case that the first adhesive member and the second adhesive member, to which the polished wafer and the first wafer mount tape are attached, include an adhesive material in which its adhesive strength is reduced by exposure to heat, the heat is applied to the first wafer mount tape and the first wafer mount tape to remove it from the wafer and the wafer ring.

In the case that the first adhesive member and the second adhesive member, to which the polished wafer and the first wafer mount tape are attached, include an adhesive material in which its adhesive strength is reduced by exposure to supersonic waves, the supersonic waves is applied to the first wafer mount tape and the first wafer mount tape to remove it from the wafer and the wafer ring.

As is apparent from the above description, by attaching the first wafer mount on which the thick wafer is disposed over the wafer ring, polishing (or etching) the rear face of the wafer to reduce the thickness of the wafer, attaching the second wafer mount tape to the rear face of the polished wafer and the wafer ring, stripping the first wafer mount tape and then transferring the wafer to the following process, it is possible to prevent the polished wafer from being deformed.

Although specific embodiments of the present invention have been described for illustrative purposes, those skilled in the art will appreciate that various modifications, additions and substitutions are possible, without departing from the scope and the spirit of the invention as disclosed in the accompanying claims.

What is claimed is:

1. A wafer mount tape, comprising:
a tape body comprising:
a first region for disposing a wafer,
a second region defined along a periphery of the first region and
a third region defined along a periphery of the second region;
a first adhesive member disposed at the first region; and
a second adhesive member disposed at the third region.

2. The wafer mount tape according to claim 1, wherein the first region has the same shape and size as the wafer.

3. The wafer mount tape according to claim 1, wherein both the first and second adhesive members having an adhesive strength capable of being weakened by exposure to light.

4. A wafer mount tape, comprising:
a first tape comprising:
a first region for disposing a wafer,
a second region defined along a periphery of the first region and
a third region defined along a periphery of the second region;
an adhesive member covering an upper face of the first tape; and
a second tape having substantially the same shape and size as the second region and covering the adhesive member disposed at the second region.

5. The wafer mount tape according to claim 4, wherein the first region has substantially the same shape and size as the wafer.

6. The wafer mount tape according to claim 5, wherein the adhesive member has an adhesive strength capable of being weakened by exposure to light.

7. A wafer processing apparatus, comprising:
a base body;
a loader disposed over the base body and accommodating a wafer ring attached to a first wafer mount tape attached to a front face of a wafer;
a wafer processing module disposed over the base body and including:
a processing unit processing a rear face of the wafer to reduce a thickness of the wafer and
a wafer chuck facing to the first wafer mount tape;
a mount tape attaching module disposed over the base body and including:
an elevator unit lifting up and down the wafer with reduced thickness and
a tape attaching unit attaching a second wafer mount tape to the rear face of the wafer and the wafer ring; and
an unloader accommodating the wafer ring to which the second wafer mount tape is attached.

8. The wafer processing apparatus according to claim 7, further comprising:
at least one transfer unit disposed over the base body and transferring the wafer ring to anyone of the loader, the wafer processing module, the mount tape attaching module and the unloader.

9. The wafer processing apparatus according to claim 7, wherein the wafer chuck includes a vacuum pressure generating unit and the wafer processing unit having a polishing wheel with at least one polishing pad.

10. The wafer processing apparatus according to claim 9, further includes an up/down unit attached to either the wafer chuck or the processing unit.

11. The wafer processing apparatus according to claim 7, further comprising a cleaning module disposed over the base body and having a cleaning chamber into which a cleaner for cleaning the wafer is provided and a cleaner supplying unit for providing the cleaner into the cleaning chamber.

12. The wafer processing apparatus according to claim 7, wherein the first wafer mount tape comprises:
a tape body having
a first region for disposing the wafer,
a second region defined along a periphery of the first region, and
a third region defined along a periphery of the second region,
a first adhesive member disposed at the first region, and
a second adhesive member disposed at the third region.

13. The wafer processing apparatus according to claim 12, wherein the first and second adhesive members both have an adhesive strength that is capable of being weakened by exposure to light.

14. The wafer processing apparatus according to claim 7, wherein the first wafer mount tape includes:
a first tape having
a first region for disposing the wafer,
a second region defined along a periphery of the first region, and
a third region defined along a periphery of the second region,
an adhesive member covering an upper face of the first tape, and
a second tape having substantially the same shape and size as the second region and covering the adhesive member disposed at the second region.

15. The wafer processing apparatus according to claim 7, further comprising a mount tape stripping module disposed over the base body and including a light generation unit generating light provided to the first wafer mount tape to strip the first wafer mount tape from the wafer ring.

16. The wafer processing apparatus according to claim 15, wherein the mount tape stripping module includes a light irradiation unit irradiating the light generated from the light generation unit onto an entire surface of the first wafer mount tape.

17. A wafer processing method, comprising the steps of:
attaching a first wafer mount tape disposed at a front face of the wafer onto a lower face of a wafer ring;
processing a rear face of the wafer to reduce a thickness of the wafer;
adjusting a height difference between the rear face of the wafer and an upper face of the wafer ring which faces to the lower face of the wafer ring; and
attaching a second wafer mount tape to the rear face of the wafer and the upper face of the wafer ring.

18. The wafer processing method according to claim 17, further comprising, before the step of attaching the first mount tape disposed at the front face of the wafer onto the lower face of the wafer ring, the steps of:
forming a tape body having
a first region attached to the wafer,
a second region defined along a periphery of the first region and
a third region defined along a periphery of the second region; and
fabricating the first wafer mount tape by forming first and second adhesive members at the first and third regions respectively.

19. The wafer processing method according to claim 17, wherein the step of processing the rear face of the wafer includes the steps of:
fixing a rear face of the first wafer mount tape opposite to a front face of the first wafer mount tape onto a wafer chuck; and
polishing the rear face of the wafer with a polishing pad.

20. The wafer processing method according to claim 19, wherein the step of processing the rear face of the wafer further includes a step of: moving up and down at least one of the wafer chuck or the polishing pad in response to the polishing of the rear face of the wafer.

21. The wafer processing method according to claim 17, wherein the step of adjusting the height difference between the rear face of the wafer and the upper face of the wafer ring which faces to the rear face of the wafer includes a step of: raising the wafer chuck disposed on the rear face of the first wafer mount tape opposite to the front face of the wafer.

22. The wafer processing method according to claim 17, further comprising, between the step of processing the rear face of the wafer to reduce a thickness of the wafer and the step of adjusting the height difference between the rear face of the wafer and the upper face of the wafer ring which faces to the rear face of the wafer, a step of cleaning the polished wafer with a cleaner.

23. The wafer processing method according to claim 17, further comprising, after the step of attaching the second wafer mount tape to the rear face of the wafer and the upper face of the wafer ring, a step of: stripping the first wafer mount tape away from the wafer and the wafer ring.

24. The wafer processing method according to claim 23, the step of stripping the first wafer mount tape includes a step of irradiating light onto an adhesive material to weaken an adhesive strength of the adhesive material prior to stripping the first wafer mount tape away from the wafer ring.
